(19) United States
(12) Patent Application Publication
(10) Pub. No.: US 2015/0037019 A1
(43) Pub. Date: Feb. 5, 2015

(54) SUSCEPTOR SUPPORT SHAFT AND KINEMATIC MOUNT

(71) Applicant: Applied Materials, Inc., Santa Clara, CA (US)

(72) Inventor: Richard O. COLLINS, Santa Clara, CA (US)

(21) Appl. No.: 14/295,457

(22) Filed: Jun. 4, 2014

Related U.S. Application Data
(60) Provisional application No. 61/861,845, filed on Aug. 2, 2013.

(51) Int. Cl. H05B 3/00; H05B 1/02

(52) U.S. Cl. CPC H05B 3/0047; H05B 1/0233
USPC 392/418; 392/416

(57) ABSTRACT

A taper assembly includes a taper housing comprising a coaxial conical shaped opening converging into a cylindrically shaped opening. A rotation housing is coupled to the taper housing by a coupling member. The rotation housing comprises a plurality of vent holes configured to vent gas through the taper assembly. A susceptor support assembly includes a central shaft having a base with a tapered bottom, a susceptor support, and a susceptor. The susceptor support includes a plurality of arms extending outwardly from the central shaft, wherein the central shaft extends through a central opening in the susceptor support. The plurality of arms are configured to house a plurality of balls in indentations in the arms. The susceptor includes a disk-shaped body having a plurality of grooves at an edge of the body. The plurality of grooves are configured to contact the plurality of balls at two or more contact points.

### CROSS-REFERENCE TO RELATED APPLICATION

This application claims benefit of U.S. Provisional Application Ser. No. 61/861,845, filed Aug. 2, 2013, which is incorporated by reference in its entirety.

### BACKGROUND OF THE DISCLOSURE

1. Field of the Disclosure

Embodiments of the present disclosure generally relate to a susceptor support assembly and a susceptor kinematic mount.

2. Description of the Related Art

Semiconductor substrates are processed for a wide variety of applications, including the fabrication of integrated devices and microdevices. One method of processing substrates includes depositing a material, such as a dielectric material or a conductive metal, on an upper surface of the substrate. For example, epitaxy is a deposition process that grows a thin, ultra-pure layer, usually of silicon or germanium on a surface of a substrate. The material may be deposited in a lateral flow chamber by flowing a process gas parallel to the surface of a substrate positioned on a support, and thermally decomposing the process gas to deposit a material from the gas onto the substrate surface.

The most common epitaxial (epi) film deposition reactors used in modern silicon technology are similar in design. Besides substrate and process conditions, however, the reactor design is essential for film quality in epitaxial growth which uses the precision of gas flow in film deposition. The design of the susceptor support assembly influences epitaxial deposition uniformity. Prior susceptor support designs restrict process uniformity with susceptor support shaft wobbling, which negatively influences deposition uniformity over the substrate. Similarly, prior susceptor designs restrict process uniformity by being non-constrained with susceptor supports and negatively moving the susceptor off of the susceptor support. Thus, there is a need for an improved susceptor support shaft and susceptor which provide for uniform deposition.

### SUMMARY OF THE DISCLOSURE

Embodiments described herein generally relate to an apparatus for heating and rotating substrates. In one embodiment, a taper assembly for a processing chamber includes a taper housing comprising a coaxial conical shaped opening extending into a cylindrically shaped opening. A rotation housing surrounds the taper housing, and the rotation housing comprises a plurality of vent holes configured to vent gas through the taper assembly. The taper assembly also includes a coupling member that couples the rotation housing to the taper housing.

In another embodiment, a susceptor support assembly includes a central shaft having a base with a tapered bottom, a susceptor support, and a susceptor. The susceptor support includes a plurality of arms extending outwardly from the central shaft, wherein the central shaft extends through a central opening in the susceptor support. The plurality of arms are configured to house a plurality of balls in indentations in the plurality of arms. The susceptor includes a disk-shaped body and has a plurality of grooves at an edge of the body. Each groove is configured to contact one of the plurality of balls at two or more contact points.

In yet another embodiment, a method of rotating a susceptor support assembly includes providing a susceptor having a disk-shaped body and plurality of grooves at an edge of the body. The plurality of grooves contact a plurality of balls on a susceptor support having the plurality of balls, such that each groove contacts one of the plurality of balls at two or more contact points. The method further includes rotating the susceptor support assembly about a center of the susceptor, such that the susceptor is constrained on the susceptor support at all times.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic view of a process chamber according to one embodiment of the disclosure.

FIG. 2 illustrates a cross-sectional view of a taper assembly according to one embodiment of the disclosure.

FIG. 3 illustrates schematic view a susceptor support assembly according to one embodiment of the disclosure.

FIG. 4A illustrates a side view of the taper assembly of FIG. 2 housing the susceptor support assembly of FIG. 3 according to one embodiment of the disclosure.

FIG. 4B illustrates a side view of the central shaft of FIG. 2 according to one embodiment of the disclosure.

FIG. 4C illustrates a front view of the central shaft of FIG. 2 according to one embodiment of the disclosure.

FIG. 5 illustrates a bottom view of a susceptor according to one embodiment of the disclosure.

FIG. 6 illustrates a cross-sectional view of the susceptor of FIG. 5 according to one embodiment of the disclosure.

FIG. 7 illustrates a top view of the susceptor of FIG. 5 mounted on a susceptor support assembly.

FIG. 8 illustrates a cross-sectional view of a taper assembly according to one embodiment of the disclosure.

FIG. 9 illustrates a front view of a central shaft according to one embodiment of the disclosure.

FIG. 10 illustrates a front view of the taper assembly of FIG. 8 housing a susceptor support assembly according to one embodiment of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following description, for purposes of explanation, numerous specific details are set forth in order to provide a thorough understanding of the present disclosure. In some instances, well-known structures and devices are shown in block diagram form, rather than in detail, in order to avoid obscuring the present disclosure. These embodiments are described in sufficient detail to enable those skilled in the art to practice the disclosure, and it is to be understood that other embodiments may be utilized and that logical, mechanical, electrical, and other changes may be made without departing from the scope of the present disclosure.

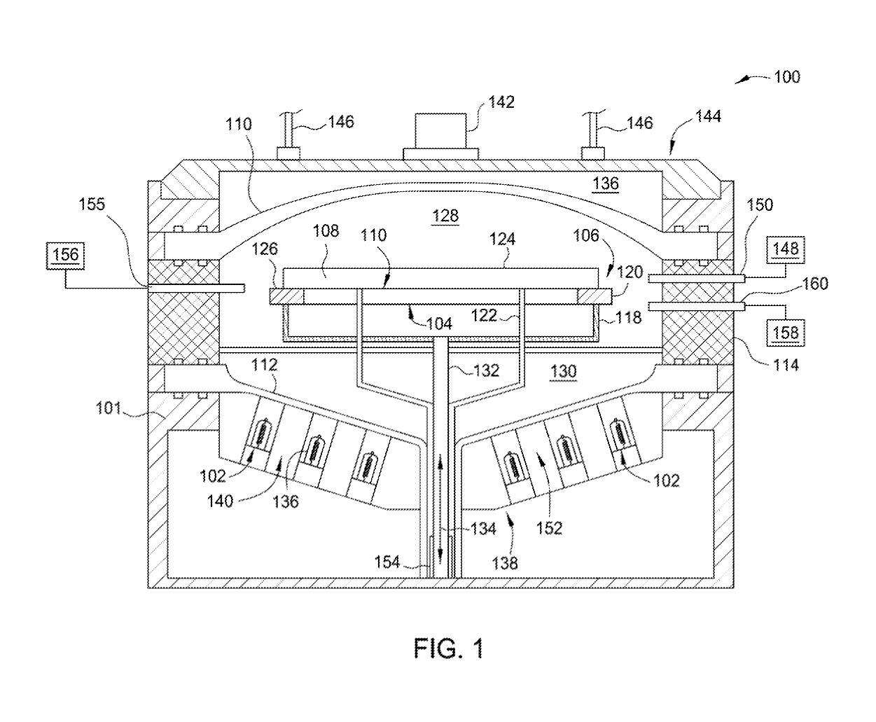

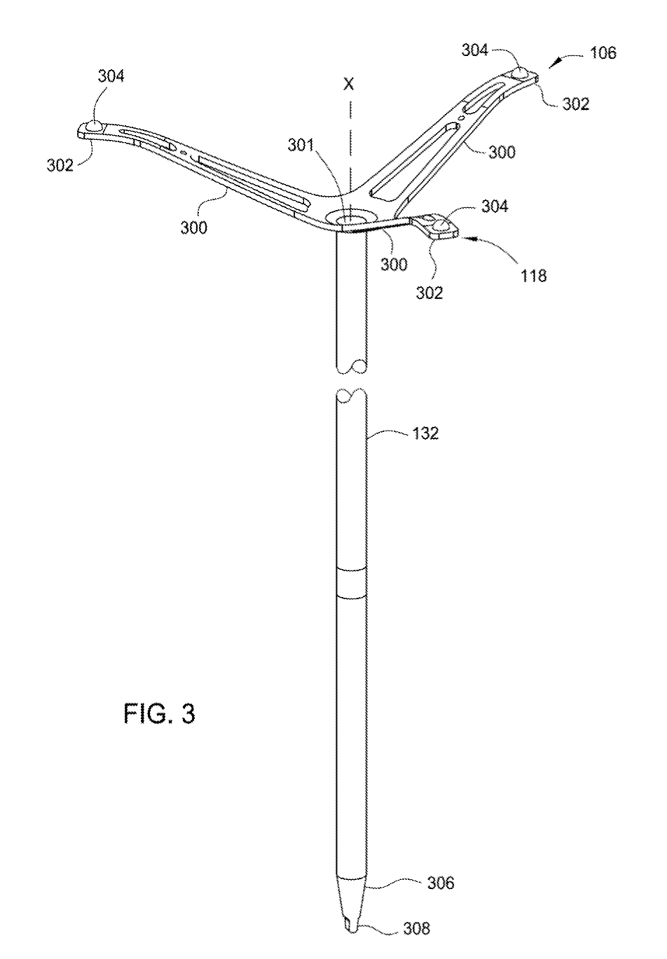

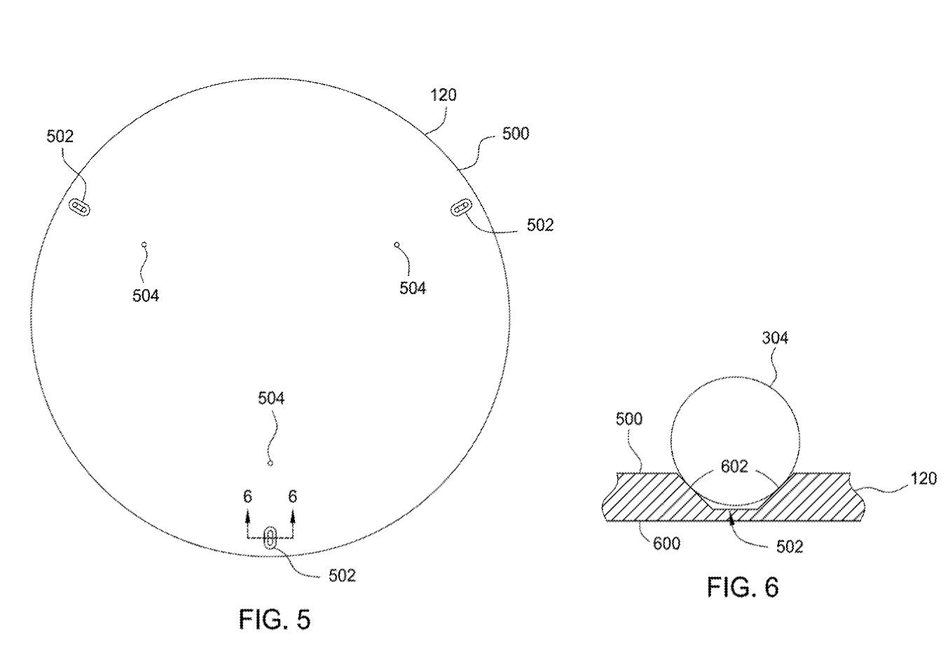

FIG. 1 illustrates a schematic view of a processing chamber 100 according to one embodiment of the disclosure. The processing chamber 100 may be used to process one or more substrates 108, including the deposition of a material on an upper surface of the substrate 108. The processing chamber 100 may include an array of radiant heating lamps 102 for heating, among other components, a back side 104 of a susceptor support assembly 106 disposed within walls 101 of the processing chamber 100. The susceptor support assembly 106 may include a disk-like susceptor support as shown, or may be a ring-like susceptor support with a central opening and supports the substrate 108 from the edge of the substrate to facilitate exposure of the substrate to the thermal radiation of the lamps 102. The susceptor support assembly 106 includes a susceptor support 118 and a susceptor 120. Details of the susceptor support 118 and the susceptor 120 will be discussed further below in reference to FIGS. 3 and 5, respectively. The susceptor support assembly 106 is located within the processing chamber 100 between an upper dome 110 and a lower dome 112. The upper dome 110, the lower dome 112 and a base ring 114 that is disposed between the upper dome 110 and lower dome 112 generally define an internal region of the processing chamber 100. In some embodiments, the array of radiant heating lamps 102 may be disposed over the upper dome 110. The substrate 108 can be brought into the processing chamber 100 and positioned onto the susceptor support assembly 106 through a loading port (not shown).

The susceptor support assembly 106 is shown in an elevated processing position, but may be vertically traversed by an actuator (not shown) to a loading position below the processing position to allow lift pins 122 to contact the lower dome 112, passing through holes in the susceptor support 118 and the susceptor, and raise the substrate 108 from the susceptor support assembly 106. A robot (not shown) may then enter the process chamber 100 to engage and remove the substrate 108 therefrom though the loading port. The susceptor support assembly 106 then may be actuated up to the processing position to place the substrate 108, with a device side 124 facing up, on a front side 126 of the susceptor 120.

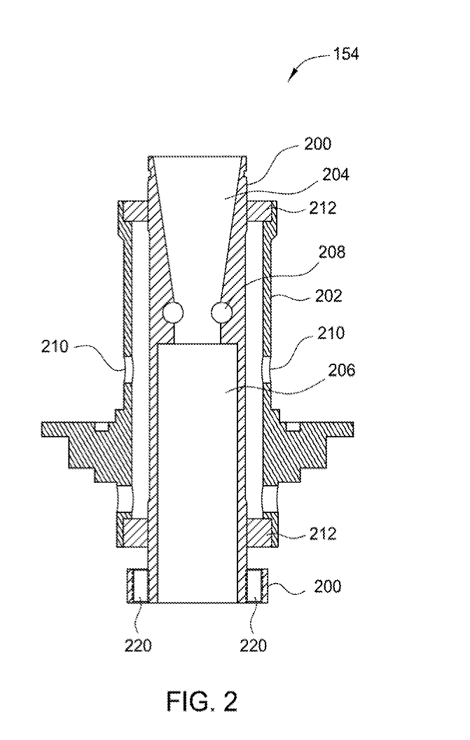

The susceptor support assembly 106, while located in the processing position, divides the internal volume of the processing chamber 100 into a process gas region 128 that is above the substrate 108, and a purge gas region 130 below the susceptor support assembly 106. The susceptor support assembly 106 is rotated during processing by a cylindrical central shaft 132 to minimize the effect of thermal and process gas flow spatial anomalies within the processing chamber 100 and thus facilitate uniform processing of the substrate 108. The susceptor support assembly 106 includes the central shaft 132 that supports the susceptor support 118 and the susceptor 120. In one embodiment, the central shaft 132 is housed in a tapper assembly 154 in the processing chamber 100. The central shaft 132 moves the substrate 108 in an up and down direction 134 during loading and unloading, and in some instances, processing of the substrate 108. Details of the central shaft 132 and the taper assembly 154 will be discussed further in detail in reference to FIGS. 2, 3 and 4. The susceptor support assembly 106 may be formed from silicon carbide or graphite coated with silicon carbide to absorb radiant energy from the lamps 102 and conduct the radiant energy to the substrate 108.

In general, the central window portion of the upper dome 110 and the bottom of the lower dome 112 are formed from an optically transparent material such as quartz. One or more lamps, such as an array of lamps 102, can be disposed adjacent to and beneath the lower dome 112 in a specified, optimal desired manner around the central shaft 132 to independently control the temperature at various regions of the substrate 108 as the process gas passes over, thereby facilitating the deposition of a material onto the upper surface of the substrate 108. While not discussed here in detail, the deposited material may include gallium arsenide, gallium nitride, or aluminum gallium nitride.

The lamps 102 may be configured to include bulbs 136 and be configured to heat the substrate 108 to a temperature within a range of about 200 degrees Celsius to about 1600 degrees Celsius. Each lamp 102 is coupled to a power distribution board (not shown) through which power is supplied to each lamp 102. The lamps 102 are positioned within a lamphead 138 which may be cooled during or after processing by, for example, a cooling fluid introduced into channels 152 located between the lamps 102. The lamphead 138 conductively and radiatively cools the lower dome 112 due in part to the close proximity of the lamphead 138 to the lower dome 112. The lamphead 138 may also cool the lamp walls and walls of the reflectors (not shown) around the lamps. Alternatively, the lower dome 112 may be cooled by a convective approach known in the industry. Depending upon the application, the lampheads 138 may or may not be in contact with the lower dome 112. As a result of backside heating of the substrate 108 from the susceptor support assembly 106, the use of an optical pyrometer 142 for temperature measurements/control on the susceptor support assembly 106 can also be performed.

A reflector 144 may be optionally placed outside the upper dome 110 to reflect infrared light that is radiating off the substrate 108 back onto the substrate 108. The reflector 144 may be fabricated from a metal such as aluminum or stainless steel. The efficiency of the reflection can be improved by coating a reflector area with a highly reflective coating such as with gold. The reflector 144 can have one or more machined channels 146 connected to a cooling source (not shown). The channel 146 connects to a passage (not shown) formed on a side of the reflector 144. The passage is configured to carry a flow of a fluid such as water and may run horizontally along the side of the reflector 144 in any desired pattern covering a portion or entire surface of the reflector 144 for cooling the reflector 144.

Process gas supplied from a process gas supply source 148 is introduced into the process gas region 128 through a process gas inlet 150 formed in the sidewall of the base ring 114. The process gas inlet 150 is configured to direct the process gas in a generally radially inward direction. During the film formation process, the susceptor support assembly 106 may be located in the processing position, which is adjacent to and at about the same elevation as the process gas inlet 150, allowing the process gas to flow up and round along a flow path across the upper surface of the substrate 108 in a laminar flow fashion. The process gas exits the process gas region 128 through a gas outlet 155 located on the side of the process chamber 100 opposite the process gas inlet 150. Removal of the process gas through the gas outlet 155 may be facilitated by a vacuum pump 156 coupled thereto. As the process gas inlet 150 and the gas outlet 155 are aligned to each other and disposed approximately at the same elevation, it is believed that such a parallel arrangement, when combing with a flatter upper dome 110 will enable a generally planar, uniform gas flow across the substrate 108. Further radial uniformity may be provided by the rotation of the substrate 108 through the susceptor support assembly 106.

Purge gas may be supplied from a purge gas source 158 to the purge gas region 130 through an optional purge gas inlet 160 (or through the process gas inlet 150) formed in the sidewall of the base ring 114. The purge gas inlet 160 is disposed at an elevation below the process gas inlet 150. The purge gas inlet 160 is configured to direct the purge gas in a generally radially inward direction. During the film formation process, the susceptor support assembly 106 may be located at a position such that the purge gas flows down and round along a flow path across the back side 104 of the susceptor support assembly 106 in a laminar flow fashion. Without being bound by any particular theory, the flowing of the purge gas is believed to prevent or substantially avoid the flow of the process gas from entering into the purge gas region 130, or to reduce diffusion of the process gas entering the purge gas region 130 (i.e., the region under the susceptor support assembly 106). The purge gas exits the purge gas region 130 and is exhausted out of the processing chamber 100 through the gas outlet 155, which is located on the side of the processing chamber 100 opposite the purge gas inlet 160.

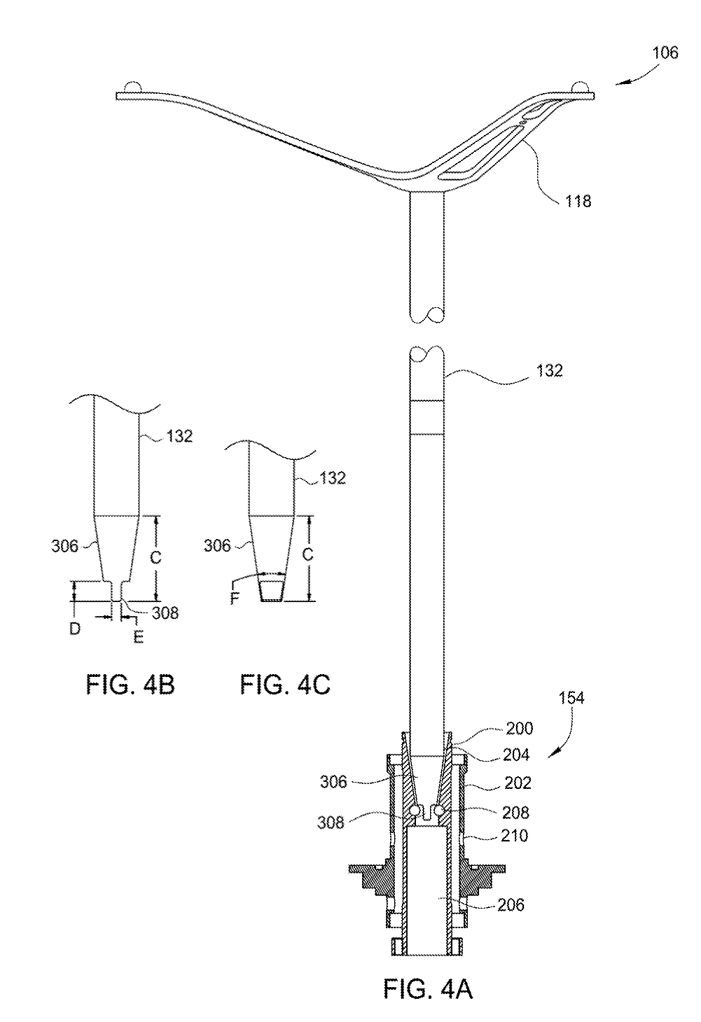

FIG. 2 illustrates a cross-sectional view of the taper assembly 154 according to one embodiment of the disclosure. The taper assembly 154 includes a tapper housing 200 configured to house the central shaft 132, and a rotation housing 202 configured to house the taper housing 200. The rotation housing 202 is connected to the taper housing 200 by a connecting member 212. In one embodiment, the taper housing 200 and the rotation housing 202 are fabricated from stainless steel. The taper housing 200 includes at least one aperture 220 at the bottom of the taper housing to house a metric screw. In one embodiment, the aperture 220 is a sink hole for a metric screw to couple the taper assembly 154 to the processing chamber 100. An inner portion of the taper housing 200 has coaxial conical shaped opening 204 configured to form a steep tapered fit with the central shaft 132. The steep tapered fit will be further discussed below in reference to FIG. 4. The coaxial conical shaped opening 204 converges into a substantially cylindrical shaped opening 206 for the remainder of the opening 204 length. A plurality of pins 208 surround the base of the coaxial conical shaped opening 204 to provide a tapered fit between the central shaft 132 and the taper housing 200. In one embodiment, the pins 208 are fabricated from polytetrafluoroethylene. The coaxial conical shaped opening 204 of the taper housing 200 advantageously prevents wobbling of the central shaft 132 by providing a tapered fit. The prevention of wobbling beneficially provides more uniform deposition on the substrate 108.

The rotation housing 202 includes a plurality of vent holes 210. The vent holes 210 are configured to allow gas to pass through the rotation housing 202 and out into the purge gas region 130. By venting the gas out of the rotation housing 202, the vent holes 210 advantageously increase the performance of lubricants or grease used in the rotation housing 202.

FIG. 3 illustrates a schematic view the susceptor support assembly 106 according to one embodiment of the disclosure. The susceptor support assembly 106 includes the central shaft 132 that supports the susceptor support 118 and the susceptor 120 (not shown in FIG. 3 for clarity). The central shaft 132 is configured to extend into a central opening 301 in the susceptor support 118. In one embodiment, the central shaft has a length between about 745 mm and about 755 mm, for example 750 mm. The central shaft 132 includes a base 306 with a tapered bottom having opposing shoulders 308. In one embodiment, the susceptor support 118 includes a plurality of support arms 300 extending from a top of the susceptor support 118, opposite the base 306. While three arms are shown in FIG. 3, it is contemplated that any number of arms may be suitable for the susceptor support 118. Each of the support arms 300 extended outwardly and angularly spaced apart from each other around the axis “X” that is extending through the central shaft 132. An edge 302 of each support arm 300 includes a groove configured to house a ball 304. The balls 304 are configured to move in a countersink groove formed in the susceptor 120. Details of the balls 304 and the susceptor 120 will be discussed later in reference to FIGS. 5-7. In one embodiment, the balls are fabricated from a group comprising silicon nitride, sapphire, zirconia oxide, alumina oxide, quartz, graphite coating, or any other suitable material for use in an epi deposition chamber. In one embodiment, the ball has a diameter between about 5 mm and about 15 mm, for example 10 mm. While three balls 304 are shown in FIG. 3, it is contemplated that any number of balls 304 may be housed in any number of support arms 300. However, three balls 304 advantageously contact the points on any plane (i.e., susceptor 120 surface).

FIG. 4A illustrates a side view of the taper assembly 154 housing the susceptor support assembly 106 according to one embodiment of the disclosure. The base 306 of the central shaft 132 forms a steep tapered fit with the coaxial conical shaped opening 204 as the opposing shoulders 308 of the central shaft 132 interface the pins 208 of the taper housing 200. As noted above, the steep tapered fit advantageously prevents any wobbling of the susceptor support assembly 106 connected to the central shaft 132.

In one embodiment, as shown in FIGS. 4B and 4C, the base 306 of the central shaft 132 has a length “C” of between about 48 mm to about 58 mm, for example 53 mm or for example 53. 14 mm. In another embodiment, the opposing shoulders 308 have a length “D” between about 7.5 mm and about 17.5 mm, for example 12.5 mm. In yet another embodiment, the opposing shoulders 308 have a width “E” between about 1 mm to about 11 mm, for example 6 mm. In another embodiment, the base 306 has a tapered angle “F” between about 11 degrees and about 21 degrees, for example 16 degrees or about 16.59 degrees.

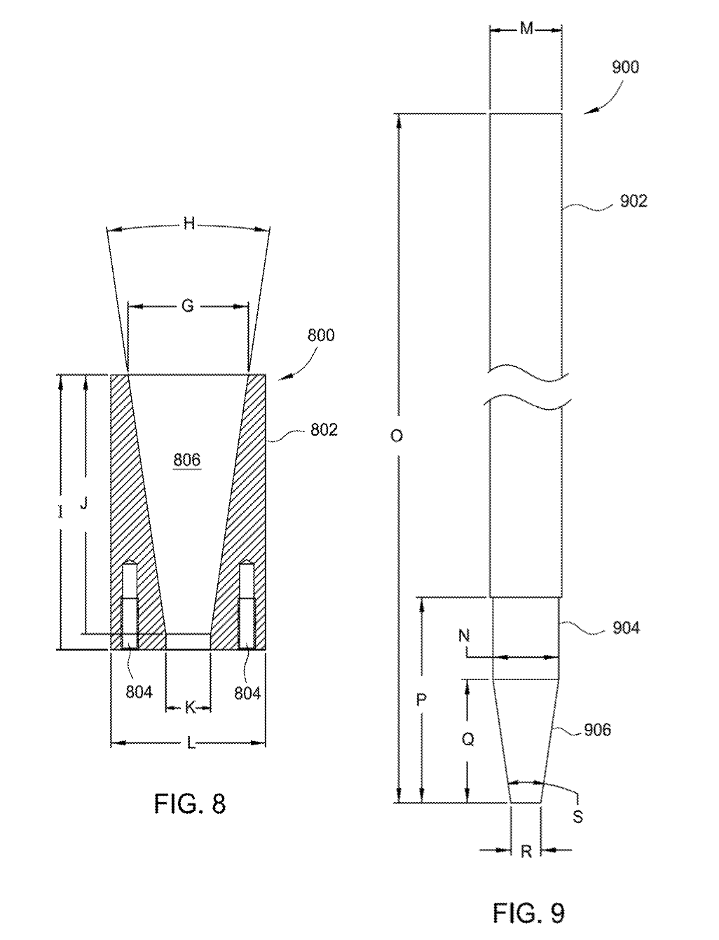

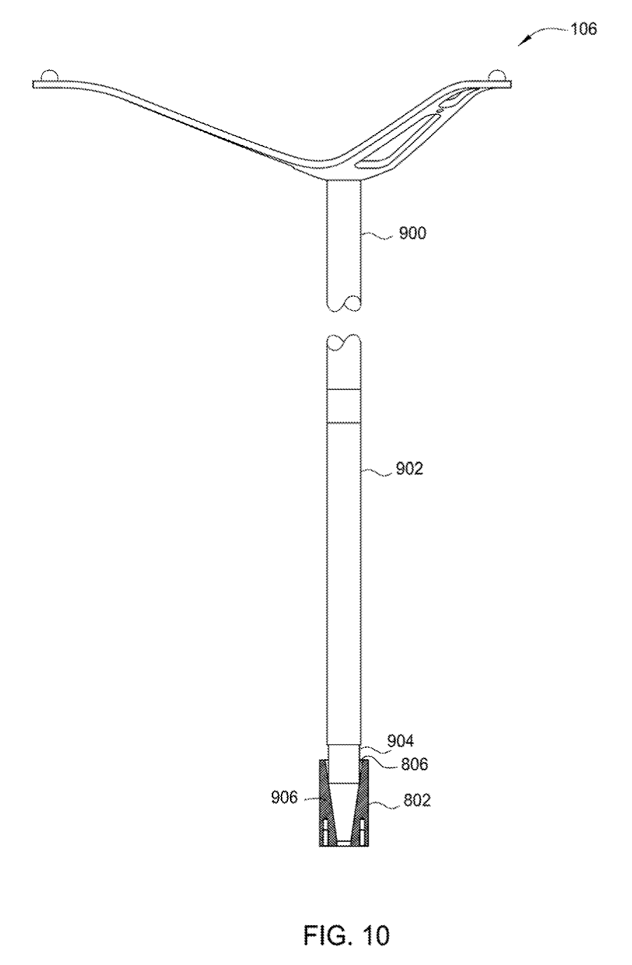

FIG. 8 illustrates a cross-sectional view of a taper assembly 800 according to another embodiment of the disclosure, and FIG. 9 illustrates one embodiment of a cylindrical central shaft 900. Referring to FIGS. 8 and 9, the taper assembly 800 includes a tapper housing 802 configured to house the central shaft 900. The taper housing 802 may be connected to the rotation housing 202 of FIG. 2 in the same manner as the taper housing 200 described above. In one embodiment, the taper housing 802 is fabricated from stainless steel. The taper housing includes at least one aperture 804 at the bottom of the taper housing 802 to house a metric screw. In one embodiment, the aperture 804 is a sink hole for a metric screw to couple the taper assembly 800 to the processing chamber 100. An inner portion of the taper housing 802 has coaxial conical shaped opening 806 configured to form a steep tapered fit with a central shaft 900. The steep tapered fit will be further discussed below in reference to FIG. 10. The coaxial conical shaped opening 806 extends into a substantially cylindrical shaped opening for the remainder of the opening length. The coaxial conical shaped opening 806 of the taper housing 800 advantageously prevents wobbling of the central shaft 900 by providing a tapered fit. The prevention of wobbling beneficially provides more uniform deposition on the substrate 108.

In one embodiment, the coaxial conical shaped opening 806 has an opening diameter “G” of between about 30 mm to about 40 mm, for example 35 mm, and a tapered angle “H” of between about 11 degrees to about 21 degrees, for example 16 degrees or about 16.59 degrees. In another embodiment, the taper housing 802 has a length “I” of between about 75 mm to about 85 mm, for example 80 mm. In yet another embodiment, the coaxial conical shaped opening 806 extends into the housing 802 for a length of “J” of between about 70 mm to about 80 mm, for example 75 mm or about 75.4 mm. In one embodiment, a bottom of the coaxial conical shaped opening 806 has diameter “K” of between about 8 mm and about 18 mm, for example 13 mm. In another embodiment, the taper housing 802 has an outer diameter “L” of between about 40 mm to about 50 mm, for example 45 mm.

In one embodiment, the central shaft 900 includes a main body 902, a middle portion 904 and a base 906. The main body 902 is connected to the middle portion 904, and the base 906 is connected to the middle portion 904. In one embodiment, the main body 902 has an outer diameter “M” of between about 20 mm to about 40 mm, for example about 25 mm or about 25.4 mm, or for example about 31 mm or about 31.8 mm, or for example about 34 mm or about 34.8 mm. In one embodiment, the central shaft 900 has a length “O” of between about 745 mm to about 755 mm, for example 750 mm. In another embodiment, the middle portion 904 has an inner diameter “N” that is less than the outer diameter M. The inner diameter N is between about 20 mm to about 37 mm, for example 25 mm, or for example 28 mm or 28.5 mm, or for example 32 mm. In one embodiment, the middle portion 904 and the base 906 comprise a length “P” of the central shaft 900, of between about 95 mm to about 105 mm, for example 100 mm. In another embodiment, the base 906 has a length “Q” of between about 35 mm to about 65 mm, for example 40 mm, or for example 50 mm, or for example 60 mm. In another embodiment, the base includes an outer diameter “R” of between about 8 mm to about 18 mm, for example about 13 mm or about 13.33 mm or about 13.92 mm, or for example about 15 mm or about 14.5 mm. In yet another embodiment, the base 906 has a tapered angle “S” of between about 11 degrees to about 21 degrees, for example about 16 degrees or about 16.59 degrees.

FIG. 10 illustrates a side view of a taper assembly 800 housing the susceptor support assembly 106 according to one embodiment of the disclosure. The base 904 of the central shaft 900 forms a steep tapered fit with the coaxial conical shaped opening 806 as the middle portion 904 and the base 906 interface the coaxial conical shaped opening 806 of the taper housing 802. As noted above, the steep tapered fit advantageously prevents any wobbling of the susceptor support assembly 106 connected to the central shaft 900.

FIG. 5 illustrates a bottom view the susceptor 120, and FIG. 6 illustrates a cross-sectional view of the susceptor 120 according to one embodiment of the disclosure. Referring to FIGS. 5 and 6, in one embodiment, the susceptor 120 has a disk-shaped body having bottom side 500, a top side 600 and a plurality of lift pin holes 504. The bottom side 500 includes a plurality of grooves 502 located at the edge of the susceptor 120. In one embodiment, the grooves 502 are have a countersink or trapezoidal track configured to contact the balls 304 on at least two contact points 602 when the susceptor 120 is placed on the susceptor support 118. In one embodiment, the indentations in the arms 300 are similar in structure to the grooves 502. The grooves 502 advantageously allow for the balls 304 to find the precise location of the contact points 602 and provide a robust fit for the balls 304 into the grooves 502. Additionally, the countersink or trapezoidal shape of the grooves 502 allows for thermal expansion of the susceptor 120 during processing. In another embodiment, the plurality of lit pin holes 504 extend through the bottom and top side 500, 600. The lift pin holes 504 allow the lift pins 122 (shown in FIG. 1) to pass through the susceptor 120, and raise the substrate 108 from the susceptor support assembly 106.

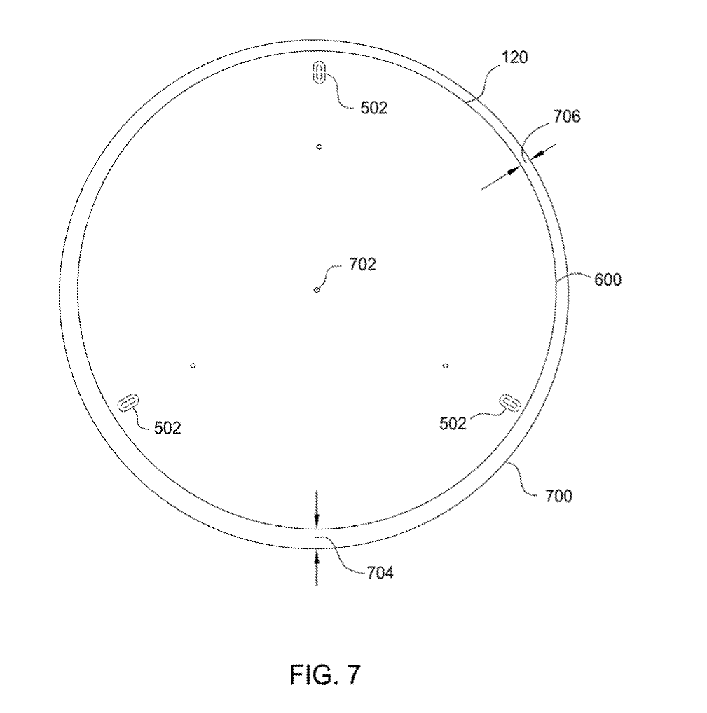

FIG. 7 illustrates a top view of the susceptor 120 on a susceptor support 700. In one embodiment, the susceptor support assembly 700 is the susceptor support assembly 118, described above. In other embodiments, the susceptor support 700 includes a susceptor support having at least the balls 304 described above. The bottom side 500 of the susceptor 120, having the plurality of grooves 502 (shown in phantom), is placed on the susceptor support assembly 700. The center of the susceptor 120 is aligned with a center 702 of the susceptor support 700, and the balls 304 contact the grooves 502. In operation, the susceptor support 700 is rotated during processing of the substrate 108 (not shown in FIG. 7 for clarity). As the susceptor support 700 is rotated about the center 702, the susceptor 120 may move off center 702. For example, the susceptor 120 may be placed a first distance 704 from the edge of the susceptor support 700 at one location and placed at a second distance 706 from the edge of the susceptor support 700 at another location. In one embodiment, the first distance 704 is greater than the second distance 706. However, the susceptor 120 advantageously remains in contact and constrained with the susceptor support 700 at all times during processing and rotation, because the balls 304 contact the grooves 502 at the two contact points 602. Thus, the susceptor 120 keeps the substrate 108 constrained on the susceptor 120 during processing and allows for uniform deposition.

While the foregoing is directed to embodiments of the present disclosure, other and further embodiments of the disclosure may be devised without departing from the basic scope thereof, and the scope thereof is determined by the claims that follow.

1. A taper assembly for a processing chamber, comprising:
a taper housing having a coaxial conical shaped opening converging into a cylindrically shaped opening;
a rotation housing surrounding the taper housing, wherein the rotation housing has a plurality of vent holes configured to vent gas through the taper assembly; and
a coupling member coupling the rotation housing to the taper housing.

2. The taper assembly of claim 1, wherein the taper housing and the rotation housing are fabricated from stainless steel.

3. The taper assembly of claim 1, further comprising:
a plurality of pins surrounding a base of the coaxial conical shaped opening.

4. The taper assembly of claim 3, wherein the pins are fabricated from polytertrafluoroethylene.

5. The taper assembly of claim 3, further comprising:
a central shaft comprising a base with a tapered bottom, wherein the central shaft is disposed in the coaxial conical shaped opening to form a tapered fit.

6. The taper assembly of claim 5, wherein the base of the central shaft has a length between about 48 mm to about 58 mm.

7. The taper assembly of claim 5, wherein the tapered bottom includes opposing shoulders that interface with the plurality of pins.

8. The taper assembly of claim 7, wherein opposing shoulders have a length between about 7.5 mm and about 17.5 mm and a width between about 1 mm to about 11 mm.

9. The taper assembly of claim 7, wherein the tapered bottom has a tapered angle between about 11 degrees and about 21 degrees.

10. A susceptor support assembly, comprising:
a central shaft comprising a base with a tapered bottom;
a susceptor support comprising a plurality of arms extended outwardly from the central shaft and a plurality of balls housed in indentations in the plurality of arms, wherein the central shaft extends through a central opening in the susceptor support; and
a susceptor comprising a disk-shaped body and having plurality of grooves at an edge of the body, wherein each groove is configured to contact one of the plurality of balls at two or more contact points.

11. The susceptor support assembly of claim 10, wherein the grooves comprise a countersink track to contact one of the plurality of balls at the at least two contact points.

12. The susceptor support assembly of claim 10, wherein the central shaft further comprises:
a main body; and
a middle portion coupled to the main body, wherein the base is coupled to the middle portion.

13. The susceptor support assembly of claim 12, wherein the central shaft has a length between about 745 mm and about 755 mm, and wherein the main body and the middle portion have a length between about 95 mm and about 105 mm.

14. The susceptor support assembly of claim 12, wherein the middle portion has an inner diameter that is less than an outer diameter of the main body.

15. The susceptor support assembly of claim 10, wherein the tapered bottom of the base has a tapered angle between about 11 degrees to about 21 degrees.

16. A method of rotating a susceptor support assembly, comprising:
providing a susceptor comprising a disk-shaped body and having plurality of grooves at an edge of the body to contact a plurality of balls on a susceptor support having a plurality of grooves, such that each groove contacts one of the plurality of balls at two or more contact points; and
rotating the susceptor support assembly about a center of the susceptor, such that the susceptor is constrained on the susceptor support at all times.

17. The method of claim 16, wherein the susceptor contacts the plurality of balls such that the susceptor is placed a greater distance from one edge of the susceptor support than at another edge of the susceptor support.

18. The method of claim 16 wherein the grooves comprise a countersink track to contact the plurality of balls.
